(19) United States
(12) Patent Application Publication
(10) Pub. No.: US 2007/0059638 A1
(43) Pub. Date: Mar. 15, 2007

(54) Photosensitive resin composition

(76) Inventors: Osamu Namba, Osaka (JP); Satoru Uchidoi, Osaka (JP)

Correspondence Address: WENDEROTH, LIND & PONACK, L.L.P., 2033 K STREET N. W., SUITE 800, WASHINGTON, DC, 20006-1021, US

(21) Appl. No.: 11/519,790

(22) Filed: Sep. 13, 2006

(30) Foreign Application Priority Data
Sep. 14, 2005 (JP) 2005-267205

(51) Int. Cl. G03C 1/00

(52) U.S. Cl. 430/270.1

(57) ABSTRACT

The present invention provides a photosensitive resin composition having improved stability in a bright room, which can provide a printing plate material having superior image remaining property and printing durability, which can be subjected to alkaline development. Accordingly, the present invention relates to a photosensitive resin composition comprising an ethylenically unsaturated compound, an alkali-soluble resin, a near-infrared-absorbing dye, a halomethyl group-containing compound, a nitroxyl compound and an organo boron anion-containing compound, and a printing plate material comprising a substrate and a photosensitive layer formed by applying the photosensitive resin composition on the substrate.

### TECHNICAL FIELD

The present invention relates to a photosensitive resin composition, which is particularly suitable for a printing plate material which can be subjected to alkaline development.

### BACKGROUND OF THE INVENTION

A photopolymerizable photosensitive resin composition has been widely utilized, for example, in the field of printing and electronic materials, as photosensitive materials such as photosensitive lithograph plates, photoresists and holograms, since the photosensitive composition is formed in order to produce a tough film having high degree of photocrosslinking and an appropriate selection of initiator readily provides considerable sensitization. Recently, technologies, especially in the field of computers and lasers, are significantly developing, and therefore, a method for directly forming an image, after electronic data processing, on a layer of photopolymerizable photosensitive resin composition with exposing to scanning laser light, which formed image is developed to provide a printing plate, is under consideration. The method is also referred to Computer to Plate (CTP) method.

In the art, many photopolymerizable photosensitive compositions are suggested for direct image formation, after electronic data processing, on a photosensitive layer comprising a photosensitive composition in accordance with various laser operation techniques (e.g., JP-A-2000-187322, etc).

JP-A-2000-187322 discloses a photosensitive composition which is characterized in containing (a) an alkali-soluble resin, (b) an infrared absorbing dye, (c) a polymerization initiator and (d) a compound having an ethylenically unsaturated double bond. The alkali-soluble resin (a) contained in the photosensitive composition may have a side chain having double bond. The polymerization initiator (c) includes organo boron complex.

JP-A-2005-202150 discloses a photosensitive layer containing IR absorbent, a polymerizable compound, a polymerization initiator comprising trihaloalkyl compound and/or organo borate, and a binder polymer having an alkali-soluble group. The structure of the binder polymer is represented therein and preferably contains a polymerizable group from the aspect of printing durability.

### SUMMARY OF THE INVENTION

It is found that the printing plate material formed with the photosensitive composition disclosed in JP-A-2000-187322 has problems associated with printability such as stability in a dark room (i.e., storage stability in a dark room without any light), image remaining property and printing durability, and the printability is insufficient. It is also found that the composition has another problem that photopolymerization is excited even under bright safety light such as yellow light and ultraviolet-screened all-round light, since the composition has photosensitivity to the visible radiation.

Generally, it is ideal that photosensitive resin compositions have no photosensitivity to non-exposure light e.g., bright safety light such as yellow light and ultraviolet-screened all-round light. Actually, the photosensitive composition (e.g., the composition disclosed in JP-A-2005-202150) has photosensitivity to non-exposure light such as safety light. Therefore, storage stability under non-exposure light (hereinafter, it is referred to as stability in a bright room) is poor and should be improved.

Protective layer having screening ability against non-exposure light can be provided on the layer of the photosensitive resin composition to improve the stability in a bright room. However, changing in the photosensitive properties of the resin composition provides improvements. Therefore, the conventional protective layer forced to assert much functions can be simplified and the printing plate materials can be readily and appropriately designed.

The present invention is to solve problems associated with the conventional photosensitive resin compositions as described above, and aiming at providing a photosensitive resin composition having improved photosensitive properties, which can provide a printing plate material superior in stability in a dark or bright room, image remaining property and printing durability, which can be subjected to alkaline development.

The present inventors studied intensively to solve these problems and found that a photosensitive resin composition comprising an ethylenically unsaturated compound, an alkali-soluble resin, a near-infrared-absorbing dye, a halomethyl group-containing compound, a nitroxyl compound and an organo boron anion-containing compound can provide a printing plate material superior in stability in a dark or bright room, image remaining property and printing durability, which can be subjected to alkaline development, in order to solve the above-described problems.

Accordingly, the present invention provides a photosensitive resin composition comprising an ethylenically unsaturated compound, an alkali-soluble resin, a near-infrared-absorbing dye, a halomethyl group-containing compound, a nitroxyl compound and an organo boron anion-containing compound.

For preferably carrying out the present invention, it is preferably that

the ethylenically unsaturated compound has 2 to 15 of (meth)acryl groups and molecular weight of 300 to 3,000, and the content of said ethylenically unsaturated compound is 30 to 90 wt %;

the alkali-soluble resin has acid value of 30 to 150 and weight average molecular weight of 5,000 to 200,000;
the alkali-soluble resin has no ethylenically unsaturated group;
the alkali-soluble resin may have an ethylenically unsaturated group as a side chain;
carboxyl group in the alkali-soluble resin has been reacted with glycidyl(meth)acrylate or an alicyclic epoxy group-containing unsaturated compound to introduce the ethylenically unsaturated group as side chain;
the alkali-soluble resin is an acrylic resin;
the near-infrared-absorbing dye is a cyanine dye and/or a polymethine dye;
the near-infrared-absorbing dye has maximum absorption wavelength of 800 to 860 nm;
the content of the near-infrared-absorbing dye is 0.05 to 20 parts by weight relative to 100 parts by weight of total amount of the ethylenically unsaturated compound and the alkali-soluble resin;
the content of the halomethyl group-containing compound is 0.1 to 20 parts by weight relative to 100 parts by weight of total amount of the ethylenically unsaturated compound and the alkali-soluble resin;
the nitroxyl compound is contained in an amount of 0.1 to 1 part by weight relative to 100 parts by weight of total amount of the ethylenically unsaturated compound and the alkali-soluble resin;
the content of the organo boron anion-containing compound is 0.1 to 20 parts by weight relative to 100 parts by weight of total amount of the ethylenically unsaturated compound and the alkali-soluble resin;
the weight ratio of the near-infrared-absorbing dye, the halomethyl group-containing compound and the organo boron anion-containing compound is 0.1 to 10 (w/w) of said halomethyl group-containing compound/said near-infrared-absorbing dye, and 0.1 to 10 (w/w) of said organo boron anion-containing compound/said near-infrared-absorbing dye; and/or
the photosensitive resin composition further comprises an organic pigment and/or an organic solvent soluble dye.

The present invention further provides a printing plate material, which comprises a substrate, a photosensitive layer formed by applying the photosensitive resin composition on the substrate, and a protective layer without masking dye provided on said photosensitive layer.

The present invention can provide a photosensitive resin composition comprising an ethylenically unsaturated compound, an alkali-soluble resin, a near-infrared-absorbing dye, a halomethyl group-containing compound, a nitroxyl compound and an organo boron anion-containing compound, which can provide a printing plate material superior in stability in a dark or bright room, image remaining property and printing durability, which can be subjected to alkaline development. Particularly, a protective layer provided on a layer of the present inventive photosensitive resin composition no needs to have shielding ability against non-exposure light. Therefore, the printing material can be easily and appropriately designed. This composition is photosensitive to the light having near-infrared wavelength, particularly 800-860 nm, and especially suitable for a printing plate material which is used as so-called Computer-to-Plate (CTP).

### DETAILED DESCRIPTION OF THE PREFERRED EMBODIMENTS

Hereinafter, the photosensitive resin composition according to the present invention is further described in detail. The photosensitive resin composition of the present invention comprises an ethylenically unsaturated compound, an alkali-soluble resin, a near-infrared-absorbing dye, a halomethyl group-containing compound, a nitroxyl compound and an organo boron anion-containing compound, as mentioned above.

Ethylenically Unsaturated Compound

The ethylenically unsaturated compounds which may be employed in the photosensitive resin composition according to the present invention include, but are not limited to, compounds having an ethylenically unsaturated double bond, which are subjected to radical addition polymerization in the presence of a photopolymerization initiator, in order to be cured.

For example, the ethylenically unsaturated compounds include acrylic acid, methacrylic acid, methyl (meth)acrylate, ethyl (meth)acrylate, n-propyl (meth)acrylate, iso-propyl (meth)acrylate, n-butyl (meth)acrylate, iso-butyl (meth)acrylate, sec-butyl (meth)acrylate, t-butyl (meth)acrylate, 2-ethylhexyl (meth)acrylate, n-nonyl (meth)acrylate, n-decyl (meth)acrylate, lauryl (meth)acrylate, n-tridecyl (meth)acrylate, stearyl (meth)acrylate, ethyleneglycol mono(meth)acrylate, propyleneglycol mono(meth)acrylate, diethyleneglycol mono(meth)acrylate, dipropyleneglycol mono(meth)acrylate, polyethyleneglycol mono(meth)acrylate having molecular weight of 200 to 1,000, polypropyleneglycol mono(meth)acrylate having molecular weight of 200 to 1,000, polyethyleneglycol-monomethyl ether mono(meth)acrylate having molecular weight of 200 to 1,000, polypropyleneglycol-monomethyl ether mono(meth)acrylate having molecular weight of 200 to 1,000, polyethyleneglycol-monoethyl ether mono(meth)acrylate having molecular weight of 200 to 1,000, polypropyleneglycol-monoethyl ether mono(meth)acrylate having molecular weight of 200 to 1,000, n-butoxyethyl (meth)acrylate, phenoxy ethyl (meth)acrylate, 2-phenoxypropyl (meth)acrylate, cyclohexyl (meth)acrylate, tetrahydrofurfuryl (meth)acrylate, glycidyl (meth)acrylate, allyl (meth)acrylate, benzyl (meth)acrylate, tribromophenyl (meth)acrylate, 2,3-dichloropropyl (meth)acrylate, 3-chloro-2-hydroxypropyl (meth)acrylate, N,N-diethylaminoethyl (meth)acrylate, N,N-dimethylaminoethyl (meth)acrylate, N-t-butylaminoethyl (meth)acrylate, ethyleneglycol di(meth)acrylate, propyleneglycol di(meth)acrylate, 1,3-propanediol di(meth)acrylate, 1,4-butanediol di(meth)acrylate, neopentylglycol di(meth)acrylate, 1,6-hexanediol di(meth)acrylate, polyethyleneglycol di(meth)acrylate, polypropyleneglycol di(meth)acrylate, glycerol di(meth)acrylate, glycerol tri(meth)acrylate, trimethylolpropane tri(meth)acrylate and trimethylolethane tri(meth)acrylate; acrylamide, ethylenebisacrylamide, ethylenebismethacrylamide, hexamethylenebisacrylamide, hexamethylenebismethacrylamide, and the like.

Preferably, the ethylenically unsaturated compounds also comprise
(I) polyurethane (meth)acrylate obtainable by reacting the following components:
(i) polyester polyol which can be obtained by, for example, reacting a diol component, such as ethyleneglycol, diethyleneglycol and 1,3-butyleneglycol, with an acid component such as dibasic acid (e.g., phthalic acid, tetrahydrophthalic acid and hexahydrophthalic acid) and anhydride thereof;
(ii) polyisocyanate (e.g., tolylenediisocyanate, 4,4′-diphenylmethanediisocyanate, isophoronediisocyanate, hexamethylenediisocyanate and the like); and
(iii) hydroxy group-containing (meth)acrylate (e.g., 2-hydroxyethyl (meth)acrylate, 2-hydroxypropyl (meth)acrylate, glycerol di(meth)acrylate, pentaerythritol tri(meth)acrylate, dipentaerythritol penta(meth)acrylate and the like);
(II) polyurethane (meth)acrylate obtainable by reacting the following components:
(i) compound having no less than three isocyanate groups therein, which is disclosed in JP-A-10-90886 (e.g., isocyanurates, burettes and adducts of diisocyanates); and
(ii) hydroxyl group-containing (meth)acrylate (e.g., 2-hydroxypropyl (meth)acrylate, 2-hydroxypropyl (meth)acrylate, glycerol di(meth)acrylate, pentaerythritol tri(meth)acrylate, dipentaerythritol penta(meth)acrylate and the like);
(III) bisphenol type epoxy acrylate obtainable by reacting bisphenol type epoxy resin (e.g., Epikote 828, Epikote 1001, Epikote 1004 and Epikote 807 by Shell, and the like) with (meth)acrylic acid;
(IV) novolac type epoxy acrylate obtainable by reacting novolac type epoxy resin (e.g., Epikote 152 and Epikote 154 by Shell) with (meth)acrylic acid; and the like.

Among the above described compounds, the ethylenically unsaturated compound which may be employed in the photosensitive resin composition according to the present invention are desirably such compounds having no less than 2, preferably 3 to 15, more preferably 4 to 15 of (meth)acryl groups and/or having molecular weight of 300 to 3,000, preferably 500 to 3,000. When the ethylenically unsaturated compound contains less than two of (meth)acryl groups, it provides poor printing durability. When the ethylenically unsaturated compound has molecular weight of less than 300, it provides higher crosslinking density and poor chip proof, and therefore it results in poor printing durability. When the compound has molecular weight of more than 3,000, it provides lower crosslinking density resulting poor printing durability.

It is desirable that the content of the ethylenically unsaturated compound is 30 to 90% by weight, preferably 40 to 80% by weight relative to total weight of the photosensitive resin composition. When the content of the ethylenically unsaturated compound is less than 30% by weight, it provides lower sensitivity resulting poor printing durability. When the content is more than 90% by weight, it provides poor solid-retaining ability, even if the products such as printing plate materials demand solid-retaining ability.

Alkali-soluble Resin

The alkali-soluble resins which may be used in the photosensitive resin composition according to the present invention include resins having carboxyl groups as side chain, resins having carboxyl groups and ethylenically unsaturated groups as side chain, and mixture thereof.

For example, the alkali-soluble resin having carboxyl groups as side chain includes resins obtainable by self-polymerization of monomer compound such as unsaturated carboxyl acids and derivatives thereof (e.g., (meth)acrylic acid, 2-succinoyloxyethyl methacrylate, 2-maleinoyloxyethyl methacrylate, 2-phthaloyloxyethyl methacrylate, 2-hexahydrophthaloyloxyethyl methacrylate, maleic acid, fumaric acid, itaconic acid and crotonic acid), and resins obtainable by copolymerization of the above cited unsaturated carboxyl acid or its derivative and at least one of vinyl monomers without carboxyl group.

The vinyl monomers without carboxyl group include
(I) hydroxyl group-containing monomers, such as 2-hydroxyethyl acrylate, hydroxypropylacrylate, 2-hydroxyethyl methacrylate, hydroxypropyl methacrylate, hydroxybutyl acrylate, hydroxybutyl methacrylate, allyl alcohol, methallyl alcohol, N-(4-hydroxyphenyl)acrylamide, N-(4-hydroxyphenyl)methacrylamide, o-, m- or p-hydroxystyrene, o-, m- or p-hydroxyphenyl acrylate and o-, m- or p-hydroxyphenyl methacrylate;
(II) alkyl(meth)acrylates, such as methyl (meth)acrylate, ethyl (meth)acrylate, n-butyl (meth)acrylate, propyl (meth)acrylate, acyl (meth)acrylate, cyclohexyl (meth)acrylate, octyl acrylate and 2-chloroethyl acrylate;
(III) polymerizable amides, such as (meth)acrylamides (e.g., acrylamide, methacrylamide, N-methylolacrylamide, N-methylolmethacrylamide, N-ethylacrylamide, N-hexylacrylamide, N-cyclohexylacrylamide, N-hydroxyethylacrylamide, N-phenylacrylamide, N-nitrophenylamide and N-ethyl-N-phenylacrylamide);
(IV) nitrogen-containing alkyl (meth)acrylates, such as dimethylaminoethyl acrylate and dimethylaminoethyl methacrylate;
(V) vinyl ethers, such as ethylvinyl ether, 2-chloroethyl vinyl ether, hydroxyethyl vinyl ether, propyl vinyl ether, butyl vinyl ether, octyl vinyl ether, and phenyl vinyl ether;
(VI) vinyl esters, such as vinyl acetate, vinyl chloroacetate, vinyl butylate and vinyl benzoate;
(VII) styrenes, such as styrene, α-methylstyrene, methylstyrene and chloromethylstyrene;
(VIII) vinyl ketones, such as methyl vinyl ketone, ethyl vinyl ketone, propyl vinyl ketone and phenyl vinyl ketone;
(IX) olefins, such as ethylene, propylene, isobutylene, butadiene and isoprene;
(X) glycidyl (meth)acrylate;
(XI) polymerizable nitriles, such as acrylonitrile and methacrylonitrile;
(XII) N-vinylpyrrolidone, N-vinylcarbazole and 4-vinylpyridine;
(XIII) zwitter-ion type monomers, such as N,N-dimethyl-N-methacryloxyethyl-N-(3-sulfopropyl)-ammonium-betaine, N,N-dimethyl-N-methacrylamidepropyl-N-(3-sulfopropyl)-ammonium-betaine and 1-(3-sulfopropyl)-2-vinylpyridinium-betaine; and the like.

The alkali-soluble resins also include resins obtainable by copolymerization of maleic anhydride and a monomer such as styrene and α-methylstyrene, and subsequent half-esterification with monoalcohol such as methanol, ethanol, propanol, butanol and hydroxyethyl (meth)acrylate, or hydrolysis with water.

Alternatively, the alkali-soluble resins include resins obtainable by addition of an unsaturated carboxyl acid or derivative thereof, such as (meth)acrylic acid, 2-succinoyloxyethyl methacrylate, 2-maleinoyloxyethyl methacrylate, 2-phthaloyloxyethyl methacrylate, 2-hexahydrophthaloyloxyethyl methacrylate, maleic acid, fumaric acid, itaconic acid and crotonic acid, or a saturated carboxyl acid such as acetic acid, propionic acid and stearic acid, to a resin such as novolac epoxy acrylate resin and bisphenol epoxy resin, and subsequent modification with an acid anhydride such as maleic anhydride, itaconic anhydride, tetrahydrophthalic anhydride and phthalic anhydride.

Among others, acrylic resins are preferably employed as alkali-soluble resin, since these acrylic resins are readily prepared and have compatibility with the ethylenically unsaturated compound as described above. For example, the preferable acrylic resins include methyl methacrylate/methacrylic acid copolymer, methyl methacrylate/methyl acrylate/methacrylic acid copolymer, benzyl methacrylate/methyl methacrylate/2-ethylhexyl methacrylate copolymer, methyl methacrylate/n-butyl methacrylate/2-ethylhexyl acrylate/methacrylic acid copolymer, styrene/acrylic acid copolymer, styrene/methacrylic acid copolymer, styrene/methyl methacrylate/methyl acrylate/methacrylic acid copolymer, styrene/methyl methacrylate/2-hydroxyethyl methacrylate/methacrylic acid copolymer, methyl methacrylate/n-butyl acrylate/2-ethylhexyl acrylate/methacrylic acid copolymer, methyl methacrylate/n-butyl acrylate/2-ethylhexyl acrylate/styrene/methacrylic acid copolymer, and the like.

The alkali-soluble resins having carboxyl groups may or may not have ethylenically unsaturated groups. Generally, the ethylenically unsaturated groups have been introduced by reacting at least one of carboxyl groups in the original alkali-soluble resin with an epoxy group-containing ethylenically unsaturated compound to produce an alkali-soluble resin having ethylenically unsaturated groups, but it is not limited.

The epoxy group-containing ethylenically unsaturated compound to be reacted with the carboxyl groups in the alkali-soluble resin to provide ethylenically unsaturated groups includes compounds such as Compound (III) having an epoxy group, and a (meth)acryloyl group or a vinyl group optionally having methyl substituent, which is disclosed in JP-B-2758737; alicyclic epoxy group-containing unsaturated compounds having a radical polymerizable unsaturated group and an alicyclic epoxy group, which is disclosed in JP-B-2763775; and the like. For example, the alicyclic epoxy group-containing unsaturated compounds include the following compounds.

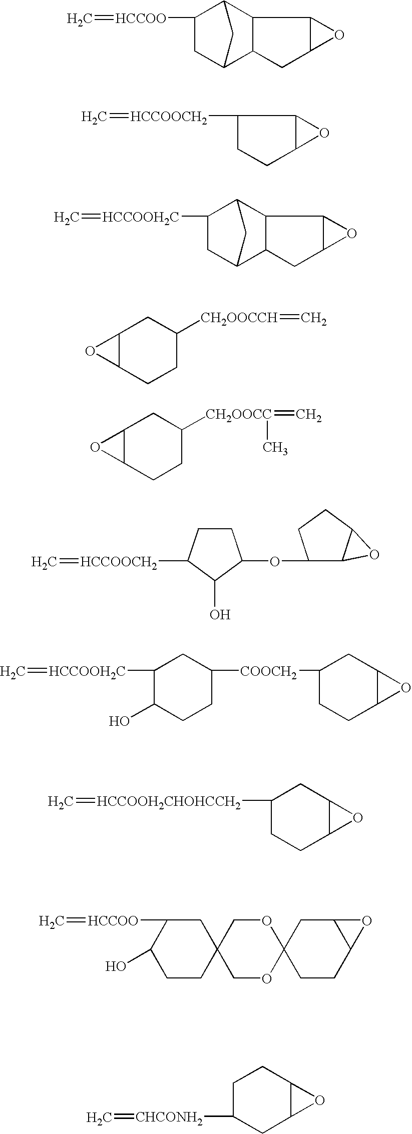

The epoxy group-containing ethylenically unsaturated compound is preferably glycidyl(meth)acrylate, (meth)acrylate having an alicyclic epoxy group, or the like.

In the present invention, the alkali-soluble resin having ethylenically unsaturated groups as side chain may be used in combination with an alkali-insoluble resin having ethylenically unsaturated groups as side chain, such as the above-described alkali-soluble resin having carboxyl groups, all of which groups had been reacted with an epoxy group-containing ethylenically unsaturated compound, such as glycidyl(meth)acrylate and 3,4-epoxycyclohexylmethyl (meth)acrylate, wherein the reaction proceeded on the epoxy moiety; an alkali-insoluble resin having hydroxyl groups which had been reacted with an isocyanate group-containing ethylenically unsaturated compound, such as methacryloyl isocyanate, 2-isocyanatoethyl acrylate, 2-isocyanoethyl methacrylate and 1,1-bis(acryloyloxymethyl)ethyl isocyanate, wherein the reaction proceeded on the isocyanate moiety; and the like. Alternatively, another alkali-insoluble resins having ethylenically unsaturated groups as side chain can be prepared in accordance with a method known to those skilled in the art and may be employed in the present invention.

Consequently, it is appreciated that the alkali-soluble resin combined with the alkali-insoluble resin has alkali-solubility. Hereinafter, the alkali-soluble resin combined with the alkali-insoluble resin may be abbreviated to an “alkali-soluble resin”, whose properties are considered as those of the mixture.

The alkali-soluble resin which may be employed in the present invention desirably has acid value of 30 to 150 KOH mg/g, preferably 50 to 130 KOH mg/g, and weight average molecular weight of 5,000 to 200,000, preferably 10,000 to 200,000. When the acid value of the alkali-soluble resin is less than 30 KOH mg/g, it provides insufficient alkaline development. When the acid value is more than 150 KOH mg/g, it provides sufficient alkaline development and a thinner layer resulting poor image remaining property.

When the weight average molecular weight of the alkali-soluble resin is less than 5,000, it provides poor printing durability and poor solid-retaining ability, even if the products such as printing plate material demand solid-retaining ability. When the weight average molecular weight is more than 200,000, it provides poor alkaline development ability.

The weight ratio of the ethylenically unsaturated compound to the alkali-soluble resin is 40:60 to 90:10, preferably 50:50 to 90:10, more preferably 60:40 to 90:10 (ethylenically unsaturated compound: alkali-soluble resin (w/w)). When the content of the alkali-soluble resin is less than 10% by weight, it provides poor alkaline development ability and poor solid-retaining ability. When the content of the alkali-soluble resin is more than 60% by weight, it provides poor printing durability.

Near-infrared-absorbing Dye

Near-infrared-absorbing dyes which may be employed in the present photosensitive resin composition have absorption wavelength of 600 to 1100 nm. The near-infrared-absorbing dyes include, for example, but are not limited to sensitizing dyes known to those skilled in the art, such as naphthoquinone dyes, anthraquinone dyes, phthalocyanine dyes, cyanine dyes and polymethine dyes. Among others, cyanine dyes and polymethine dyes are preferable. Particularly preferable dyes are those having maximum absorption wavelength of 800 to 860 nm.

The most preferable embodiments of the near-infrared-absorbing dyes are listed below in way of exemplification, but not limitation.

Cyanine dyes having quinoline structure, such as 1-ethyl-4-[5-(1-ethyl-4(1H)-quinolinylidene)-1,3-pentadienyl]quinolinium iodide (maximum absorption wavelength: 814 nm; MeOH): 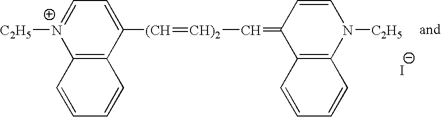
1-ethyl-2-[7-(1-ethyl-2(1H)-quinolinylidene)-1,3,5-heptatrienyl]quinolinium iodide (maximum absorption wavelength: 817 nm; MeOH):

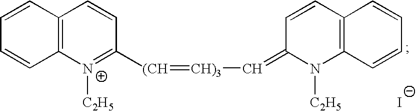

Cyanine dyes having benzopyrylium structure, such as 8-[(6,7-dihydro-2,4-diphenyl-5H-1-benzopyran-8-yl)methylene]5,6,7,8-tetrahydro-2,4-diphenyl-1-benzopyrylium perchlorate (maximum absorption wavelength: 840 nm; dichloroethane):

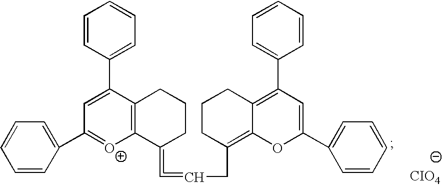

Cyanine dyes having benzothiazole structure, such as 5-chloro-2-[2-[3-[2-(5-chloro-3-ethyl-2(3H)-benzothiazolylidene)ethylidene ]-2-diphenylamino-1-cyclopenten-1-yl]ethenyl]-3-ethylbenzothiazolium perchlorate (maximum absorption wavelength: 825 nm; DMSO): 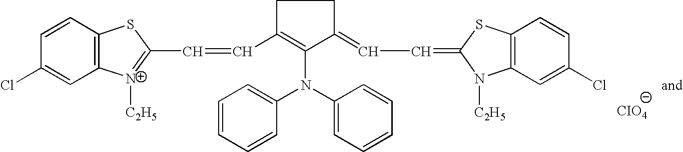
3-ethyl-2-[2-[3-[2-(3-ethyl-2(3H)-benzothiazolylidene) ethylidene]-2-diphenylamino-1-cyclopenten-1-yl]ethenyl]benzothiazolium perchlorate (maximum absorption wavelength: 831 nm; DMSO):

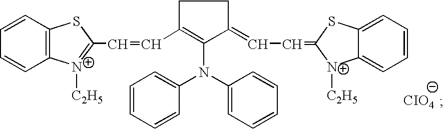

Cyanine dyes having indole structure, such as 2-[2-[2-chloro-3-[(3-ethyl-1,3-dihydro-l,1-dimethyl-2H-benz[e]indol-2-ylidene)ethylidene]-1-cyclohexen-1-yl]ethenyl]-1,1-dimethyl-3-ethyl-1H-benz[e]indolium tetrafluoroborate (maximum absorption wavelength: 816 nm; MeOH): 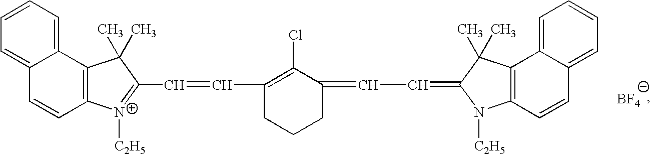
3-butyl-1,1-dimethyl-2-(2[2-diphenylamino-3-[(3-butyl-1,3-dihydro-1,1-dimethyl-2H-benz[e]indol-2-ylidene)ethylidene]-1-cyclopenten-1-yl]ethyenyl]-1H-benz[e]indolium perchlorate (maximum absorption wavelength: 830 nm; MeOH): 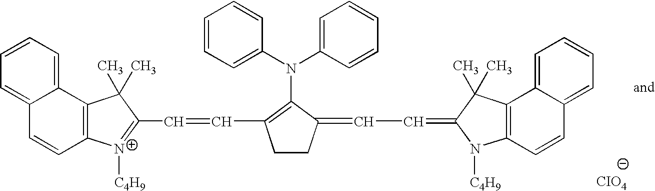
2[2-[2-chloro-3-[(3-ethyl-1,3-dihydro-1,1-dimethyl-2H-benz [e]indol-2-ylidene)ethylidene]-1-cyclopentene-1-yl ]ethenyl]-1,1-dimethyl-3-ethyl-1H-benz[e]indolium iodide (maximum absorption wavelength: 841 nm; MeOH):

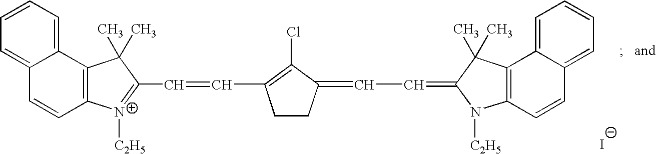

Polymethine dyes such as 1,1,5,5-tetrakis[4-(diethylamino)phenyl ]-1,4-pentadien-3-ylium p-toluenesulfonate (maximum absorption wavelength: 817 nm; AcCN (acetonitrile)): 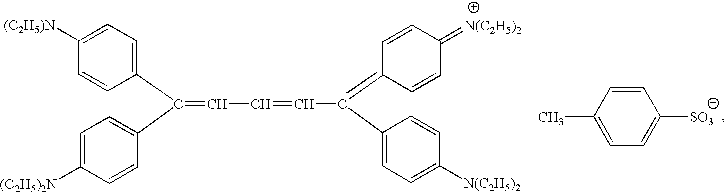
1,5-bis[4-(diethylamino)phenyl]-1,5-bis(4-methoxyphenyl)-1,4-pentadien-3-ylium trifluoromethanesulfonate (maximum absorption wavelength: 819 nm; ACCN): 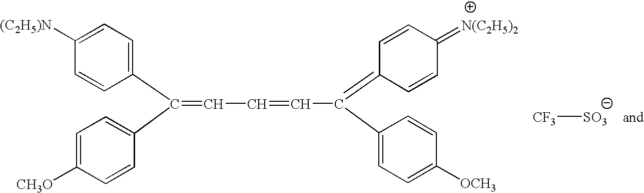
1,1,5,5-tetrakis(4-(diethylamino)phenyl]-1,4-pentadien-3-ylium butyl(triphenyl)borate (maximum absorption wavelength: 820 nm; AcCN):

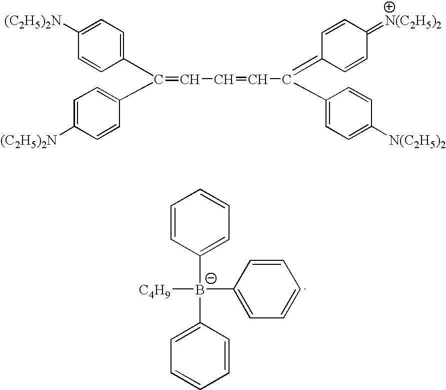

Content of the near-infrared-absorbing dye in the present photosensitive resin composition is 0.05 to 20 parts by weight, preferably 0.5 to 10 parts by weight relative to 100 parts by weight of the total-amount of the ethylenically unsaturated compound and the alkali-soluble resin. When the content of the near-infrared-absorbing dye is less than 0.05 parts by weight, it provides insufficient curing property. When the content is more than 20 parts by weight, it provides difficulty in curing the bottom area.

Halomethyl group-containing Compound

The halomethyl group-containing compounds which can be employed in the photosensitive resin composition according to the present invention include S-triazine compounds having at least one of methyl groups wherein at least one of the hydrogen atoms therein is substituted with chlorine atom(s) or bromine atom(s), such as S-triazine compound represented by Formula: 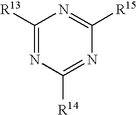
wherein R¹³, R¹⁴ and R¹⁵ are each independently a trichloromethyl group, an alkyl group having 1 to 10 carbon atoms, which may preferably have 1 to 4 substituents, an aryl group having 6 to 15, preferably 6 to 10 carbon atoms, an aralkyl group having 7 to 25, preferably 7 to 14 carbon atoms, an alkoxy group having 1 to 10, preferably 1 to 4 carbon atoms, an alkenyl group having 2 to 15, preferably 2 to 10 carbon atoms, a piperidino group, a piperonyl group, an amino group, a dialkylamino group having 2 to 20, preferably 2 to 8 carbon atoms, a thiol group or an alkylthio group having 1 to 10, preferably 1 to 4 carbon atoms, with the proviso that at least one of R¹³ to R¹⁵ is a trichloromethyl group;
preferably such S-triazine compounds wherein at least one of the trichloromethyl groups is attached to the carbon atom in the S-triazine structure, as well as, compounds having a tribromomethylsulfonyl group, such as tribromomethylphenylsulfone, 2-tribromomethylsulfonyl-pyridine and 2-tribromomethylsulfonylbenzthiazole, etc.

Particularly preferable examples of the S-triazine compounds, which can be used in the present invention, include 2,4,6-tris(trichloromethyl)-S-triazine, 2-methyl-4, 6-bis(trichoromethyl)-S-triazine, 2-methoxy-4,6-bis(trichloromethyl)-S-triazine, 2-phenyl-4,6-bis(trichloromethyl)-S-triazine, 2-(p-methoxyphenyl)-4,6-bis(trichloromethyl)-S-triazine, 2-(4-methylthiophenyl)-4,6-bis(trichloromethyl)-S-triazine, 2-(p-c hlorophenyl)-4,6-bis(trichloromethyl)-S-triazine, 2-(4-methoxynaphthyl)-4,6-bis(trichloromethyl)-S-triazine, 2-piperonyl-4,6-bis(trichloromethyl)-S-triazine, 2-piperidino-4,6-bis(trichloromethyl)-S-triazine, 2-styryl-4,6-bis(trichloromethyl)-S-triazine, 2-(p-methoxystyryl)-4,6-bis(trichloromethyl)-S-triazine, 2-(3,4-dimethoxystyryl)-4,6-bis(trichloromethyl)-S-triazine, 2-(p-dimethylamino-styryl)-4,6-bis(trichloromethyl)-S-triazine.

In the photosensitive resin composition of the present invention, the content of the halomethyl group-containing compound is 0.1 to 20 parts by weight, preferably 1 to 10 parts by weight relative to 100 parts by weight of the total amount of the ethylenically unsaturated compound and the alkali-soluble resin. When the amount of the halomethyl group-containing compound is less than 0.1 part by weight, it provides insufficient curing. When the amount is more than 20 parts by weight, it provides poor properties of the cured product, e.g., lower solvent resistance.

Organo Boron anion-containing Compound

The organo boron anion-containing compound which can be employed in the photosensitive resin composition according to the present invention must be represented by Formula (a): 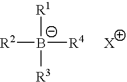
wherein
R¹, R², R³ and R⁴ are each independently an alkyl group having 1 to 10 carbon atoms, an aryl group having 6 to 15 carbon atoms, an alkaryl group having 2 to 10 carbon atoms, an allyl group, an aralkyl group having 1 to 10 carbon atoms, an alkenyl group having 1 to 10 carbon atoms or an alkynyl group having 1 to 10 carbon atoms, each of which may have a substituent, and
X⁺is a counter cation, or an alkaline metal cation such as sodium cation and lithium cation, or phosphonium cation.

It is desirable that the organo boron anion-containing compound according to the present invention is a compound represented by Formula (b): 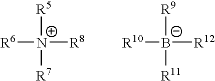
wherein
R⁵, R⁶, R⁷ and R⁶ are each independently an alkyl group having 1 to 10 carbon atoms, an aryl group having 6 to 15 carbon atoms, an alkaryl group having 2 to 10 carbon atoms, an allyl group, an aralkyl group having 1 to 10 carbon atoms, an alkenyl group having 1 to 10 carbon atoms, an alkynyl group having 1 to 10 carbon atoms, a silyl group, an alicyclic group or a heterocyclic group, each of which may have a substituent and/or a cyclic structure, and R⁹, R¹⁰, R¹¹ and R¹² are each independently an alkyl group having 1 to 10 carbon atoms, an aryl group having 6 to 15 carbon atoms, an alkaryl group having 2 to 10 carbon atoms, an allyl group, an aralkyl group having 1 to 10 carbon atoms, an alkenyl group having 1 to 10 carbon atoms or an alkynyl group having 1 to 10 carbon atoms, each of which may have a substituent, with the proviso that at least one of R⁹, R¹⁰, R¹¹ and R¹² is preferably an alkyl group.

The organo boron anion-containing compound represented by the Formula (a) includes, for example, sodium tetraphenylborate, lithium triphenyl-n-butylborate, tetraphenylphosphonium tetrakis(4-methylphenyl)borate, tetraphenylphosphonium tetraphenylborate, benzyltriphenylphosphonium tetraphenylborate, 4-methylphenyltriphenylphosphonium tetrakis(4-methylphenyl)-borate, and the like.

The organo boron anion-containing compound represented by the Formula (b) includes, for example, tetramethylammonium tetraphenylborate, tetraethylammonium tetraphenylborate, tetramethylammonium tetraanisylborate, 1,5-diazabicyclo[4.3.0]nonene-5-tetraphenylborate, 1,8-diazabicyclo [5.4.0]undecene-7-tetraphenylborate, 2-ethyl-4-methylimidazolium tetraphenylborate, tetramethylammonium triphenyl-n-butylborate, tetramethylammonium triphenyl n-octylborate, tetraethylammonium triphenyl-n-butylborate, tetramethylammonium trianisyl-n-butylborate, tetraethylammonium diphenyl-di-n-butylborate, and the like.

In the photosensitive resin composition of the present invention, the content of the organo boron anion-containing compound is 0.1 to 20 parts by weight, preferably 1 to 10 parts by weight relative to 100 parts by weight of the total amount of the ethylenically unsaturated compound and the alkali-soluble resin. When the content of the organo boron anion-containing compound is less than 0.1 part by weight, it provides insufficient curing. When the content is more than 20 parts by weight, it provides a cured product having poor properties such as poor solvent resistance.

In the photosensitive resin composition of the present invention, desirable weight ratio of the organo boron anion-containing compound to the near-infrared-absorbing dye is 0.1 to 10, preferably 0.2 to 5 (w/w), and desirable weight ratio of the halomethyl group-containing compound to the near-infrared-absorbing dye is 0.1 to 10, preferably 0.2 to 5 (w/w).

Nitroxyl Compound

The photosensitive resin composition of the present invention includes a nitroxyl compound. The nitroxyl compound can significantly improve stability in a dark room of the printing plate material formed by the photosensitive resin composition according to the present invention, especially for CTP (Computer-to-Plate), which has photosensitivity to the light having wavelength of 830 nm. Surprisingly, use of the present photosensitive resin composition having a nitroxyl compound can significantly improve the stability in a bright room of the composition, as well. Therefore, there is no need to screen against irritating light, i.e., non-exposure light, for example, by adding a masking dye (i.e., dye which can absorb non-exposure light enable the photosensitive resin layer to be ineffective) to a protective layer provided on the photosensitive layer. It is considered that the photosensitive properties of the composition provide such improvement.

The nitroxyl compounds include nitroxyl compounds which have been conventionally used in the art, for example, such that specifically described in JP-A-10-97059, but are not limited to di-tert-butylnitroxyl, 1-oxyl-2,2,6,6-tetramethylpiperidine, 1-oxyl-2,2,6,6-tetramethylpiperidin-4-ol, 1-oxyl-2,2,6,6-tetramethylpiperidin-4-one, 1-oxyl-2,2,6,6-tetramethylpiperidin-4-ylacetate, 1-oxyl-2,2,6,6-tetramethylpiperidin-4-yl-2-ethylhexanoate, 1-oxyl-2,2,6,6-tetramethylpiperidin-4-ylstearate, 1-oxyl-2,2,6,6-tetramethylpiperidin-4-ylbenzoate, 1-oxyl-2,2,6,6-tetramethylpiperidin-4-yl 4-tert-butylbenzoate, bis(1-oxyl-2,2,6,6-tetramethylpiperidin-4-yl)succinate, bis(1-oxyl-2,2,6,6-tetramethylpiperidin-4-yl)adipate, bis(1-oxyl-2,2,6,6-tetramethylpiperidin-4-yl)sebacate, bis(1-oxyl-2,2,6,6-tetramethylpiperidin-4-yl)-n-butylmalonate, bis(1-oxyl-2,2,6,6-tetramethylpiperidin-4-ly)phthalate, bis(1-oxyl-2,2,6,6-tetramethylpiperidin-4-yl)isophthalate, bis(1-oxyl-2,2,6,6-tetramethylpiperidin-4-yl)terephthalate, bis(1-oxyl-2,2,6,6-tetramethylpiperidin-4-yl)hexahydroterephthalate, N,N′-bis(1-oxyl-2,2,6,6-tetramethylpiperidin-4-yl)adipamide, N-(1-oxyl-2,2,6,6-tetramethylpiperidin-4-yl)caprolactam, N-(1-oxyl-2,2,6,6-tetramethylpiperidin-4-yl)dodecylsuccinimide, 2,4,6-tris(1-oxyl-2,2,6,6-tetramethylpiperidin-4-yl)isocyanurate, 2,4,6-tris(N-butyl-N-(1-oxyl-2,2,6,6-tetramethylpiperidin-4-yl)]-S-triazine and 4,4′-ethylenebis(1-oxyl-2,2,6,6-tetramethylpiperadin-3-one). The most preferable is bis(1-oxyl-2,2,6,6-tetramethylpiperidin-4-yl)sebacate.

Content of the nitroxyl compound in the composition is 0.1 to 1 part by weight, preferably 0.1 to 0.5 part by weight, more preferably 0.1 to 0.3 part by weight relative to 100 parts by weight of the total amount of the ethylenically unsaturated compound and the alkali-soluble resin. When the content is less than 0.1 part by weight, storage stability can not be obtained. When the content is more than 1 part by weight, it is difficult to cure the resulting photosensitive layer.

Other Additives

The photosensitive resin composition according to the present invention may desirably contain an organic pigment and /or an organic solvent soluble dye as coloring agent, which can visually indicate whether image is appropriately formed on a printing plate material formed by the composition, i.e., which can improve visibility of the material, so that the material is conveniently handled. The photosensitive resin composition of the present invention is colored in any color, preferably in red or blue, but which is not limited. The organic pigment and dye include azo pigments, phthalocyanine pigments, azo dyes, etc. Use of the organic pigment in the photosensitive resin composition can inhibit adherence of the resulting photosensitive layer, while it improves visibility.

Content of the coloring agent contained in the photosensitive resin composition of the present invention is 1 to 50 parts by weight, preferably 5 to 45 parts by weight relative to 100 parts by weight of the total amount of the ethylenically unsaturated compound and the alkali-soluble resin. When the content is more than 50 parts by weight, it is difficult to cure the photosensitive layer formed by the composition. When the content is less than 1 part by weight, it provides insufficient visibility.

Further additives may be incorporated in the photosensitive resin composition of the present invention, such as solvents, matting agents, loading agents, heat-polymerization inhibitors, plasticizers, surfactants to improve coating properties, anti-foam agent and inorganic or organic fine particle fillers. Preferable inorganic fillers include silica fine powder (particle size: 0.001 to 2 μm) and colloidal silica dispersed in solvents (particle size: 0.001 to 1 μm). Preferable organic fillers include microgel which core is gel (particle size: 0.01 to 5 μm). For example, such particularly preferable microgel is disclosed in JP-A-4-274428, wherein microgel having particle size of 0.01 to 2 μm is prepared by emulsion polymerization by using a polymer emulsifier having Sp value of 9 to 16.

The photosensitive resin composition of the present invention can be prepared in accordance with the conventional methods, for example, which include mechanically stirring and mixing the above components under shading with an apparatus known to those skilled in the art, such as high speed stirrers.

Preparation of Printing Plate

The photosensitive resin composition according to the present invention, which can be subjected to alkaline development, can provide a printing plate. The printing plate can be prepared in accordance with a conventional method, for example, which includes first step of applying the present photosensitive resin composition, which can be subjected to alkaline development, on an appropriate substrate. The substrate includes, for example, plates of metal such as aluminum (including aluminum alloy), zinc and copper as well as materials wherein the above listed metal is laminated or deposited on a plastic film such as cellulose diacetate, cellulose triacetate, cellulose propionate, cellulose acetate, methylcellulose acetate, ethylcellulose acetate, cellulose nitrate, polyethylene terephthalate, polyethylene, polystyrene, polypropylene, polycarbonate, polyvinyl acetal, etc. Among others, aluminum plate is particularly preferable as a substrate, since aluminum plate is significantly stable in its size and has considerably light weight and low price. Laminated sheet wherein an aluminum sheet is attached on the polyethylene terephthalate film, which is disclosed in JP-B-48-18327, is also preferable. In the case that substrate having metallic surface, particularly aluminum surface, is used, it is desirable that the surface is hydrophilically treated in accordance with the known methods.

For example, the applying manner includes coating by a bar coater, but is not particularly limited. Subsequently, the coated substrate is dried, for example, at 60 to 100° C. for 1 to 10 minutes. It is preferable that the coated amount after drying is about 0.5 to 2.5 g/m². Appropriately, a protective layer may be formed by further applying a resin soluble in an alkaline developing solution, such as polyvinyl alcohol, hydroxypropyl methylcellulose, and the like, and then drying.

Although only some exemplary embodiments of this invention have been described in detail above, those skilled in the art will readily appreciated that many modifications are possible in the exemplary embodiments without materially departing from the novel teachings and advantages of this invention. Accordingly, all such modifications are intended to be included within the scope of this invention.

### EXAMPLES

The present invention is further described below according to Examples in only way of exemplification, but the present invention is not limited to these examples.

Synthesis of Acrylic Resin A

1260 g of diethyleneglycol dimethyl ether (DMDG) was weighted in a 4 L flask and heated to 110° C. with stirring. A mixture of 280 g of styrene (ST), 532 g of methyl methacrylate (MMA), 276 g of methacrylic acid (MAA) and 111 g of 2-hydroxyethyl methacrylate (HEMA), which had been accurately weighted in advance, and 12 g of Kaya-ester O initiator dissolved in 360 g of DMDG as a mixture were individually added dropwise into the flask over 3 hours. Followed by the dropwise addition, after 30 minutes, 2.5 g of Kaya-ester O initiator dissolved in 180 g of DMDG as a mixture was further added dropwise over 30 minutes. Followed by the dropwise addition, reaction temperature was raised to 120° C. and maintained for 2 hours, and then cooled to give an acrylic resin (acrylic resin A). The resulted acrylic resin A had resin properties: nonvolatile contents =43.4%; bubble viscosity=Z2; acid value of varnish=61.5 mgKOH/g; acid value of resin=141.7 mgKOH/g; number average molecular weight (Mn)=16,100; weight average molecular weight (Mw)=59,300; molecular weight distribution (Mw/Mn)=3.68.

Synthesis of Acrylic Resin I

1507 g of acrylic resin A, 430 g of diethyleneglycol dimethyl ether (DMDG), 0.25 g of tetrabutylammonium bromide and 0.24 g of methoxyphenol were weighted in a 3 L flask, to which air was purged, and heated to 100° C. with stirring. 114 g of glycidyl methacrylate (GMA), which had been accurately weighted in advance, was added dropwise into the flask over 1 hour. Followed by the dropwise addition, after 3 hours, acid value of varnish was measured and confirmed (23.0 mgKOH/g), and then reaction system was cooled to give an acrylic resin (acrylic resin I). The resulted acrylic resin I had resin properties: nonvolatile contents=34.8%; bubble viscosity=M-N; acid value of varnish=22.8 mgKOH/g (acid value of resin=65.5 mgKOH/g); number average molecular weight (Mn)=16,300; weight average molecular weight (Mw)=84,100; molecular weight distribution (Mw/Mn)=5.16.

Synthesis of Acrylic Resin B

1260 g of diethyleneglycol dimethyl ether (DMDG) was weighted in a 4 L flask and heated to 110° C. with stirring. A mixture of 280 g of styrene (ST), 532 g of methyl methacrylate (MMA) and 387 g of 2-hydroxyethyl methacrylate (HEMA), which had been accurately weighted in advance, and 12 g of Kaya-ester o initiator dissolved in 360 g of DMDG as a mixture were individually added dropwise into the flask over 3 hours. Followed by the dropwise addition, after 30 minutes, 2.5 g of Kaya-ester O initiator dissolved in 180 g of DMDG as a mixture was further added dropwise over 30 minutes. Followed by the dropwise addition, reaction temperature was raised to 120° C. and maintained for 2 hours, and then cooled to give an acrylic resin (acrylic resin B). The resulted acrylic resin B had resin properties: nonvolatile contents=43.2%; bubble viscosity =Y; number average molecular weight (Mn)=15,300; weight average molecular weight (Mw)=53,700; molecular weight distribution (Mw/Mn)=3.51.

Synthesis of Acrylic Resin II

1507 g of acrylic resin B, 430 g of diethyleneglycol dimethyl ether (DMDG), 0.8 g of DBTL catalyst and 2.3 g of MEHQ polymerization inhibitor were weighted in a 4 L flask, and heated to 80° C. with stirring. Gradually, 130 g of 2-isocyanatoethyl acrylate, which had been accurately weighted in advance, was added dropwise into the flask over 1 hour. Followed by the dropwise addition, after 1 hour, absorption peak of isocyanate group at 2220 cm⁻was traced with IR spectrometer. Upon confirming the absorption intensity turned zero, the reaction was quenched to give a desired acrylic resin (acrylic resin II). The resulted acrylic resin II had resin properties: nonvolatile contents =34.6%; bubble viscosity=S; number average molecular weight (Mn)=15,500; weight average molecular weight (Mw)=59,800; molecular weight distribution (Mw/Mn)=3.85.

Synthesis of Acrylic Resin III

1260 g of diethyleneglycol dimethyl ether (DMDG) was weighted in a 4 L flask and heated to 110° C. with stirring. A mixture of 280 g of styrene (ST), 532 g of methyl methacrylate (MMA), 133 g of methacrylic acid (MAA) and 254 g of 2-hydroxyethyl methacrylate (HEMA), which had been accurately weighted in advance, and 12 g of Kaya-ester O initiator dissolved in 360 g of DMDG as a mixture were individually added dropwise into the flask over 3 hours. Followed by the dropwise addition, after 30 minutes, 2.5 g of Kaya-ester O initiator dissolved in 180 g of DMDG as a mixture was further added dropwise over 30 minutes. Followed by the dropwise addition, reaction temperature was raised to 120° C. and maintained for 2 hours, and then cooled to give an acrylic resin (acrylic resin III). The resulted acrylic resin III had resin properties: nonvolatile contents=43.1%; bubble viscosity=Z; acid value of varnish=31.2. mgKOH/g (acid value of resin=72.3 mgKOH/g); number average molecular weight (Mn)=15,300; weight average molecular weight (Mw)=53,700; molecular weight distribution (Mw/Mn)=3.51.

### Examples 1 to 7 and Comparative Examples 1 to 7

Solution of the photosensitive resin composition containing components (see Tables 1 and 2) in organic solvent (methoxy propanol, 8%) was applied on an aluminum substrate, which had been hydrophilically treated, by a bar coater, and dried at 80° C. for 5 minutes. The coated amount after drying was ca. 1 g/m2.

7% aqueous solution of partially saponified polyvinyl acetate (POVAL 205 produced by KURARAY CO., LTD.) was applied thereon by a bar coater, and dried at 60° C. for 5 minutes. The coated amount after drying was ca. 1.5 g/m². The prepared photosensitive resin composition was evaluated in ink scumming in addition to image remaining property as well as rubbing resistance instead of the printing durability. Results are shown in the following Tables 1 and 2. Image remaining property, rubbing resistance and ink scumming were evaluated immediately after the preparation as well as after 7 days storage at 45° C. and 75% relative humidity after the preparation in accordance with the each evaluation basis. The testing procedures are as follows.

Testing Procedures

(1) Image remaining property

The prepared printing plate was exposed and drawn (at 6 W) with Creo Trendsetter NEWS by using 50% screening pattern. A developer (DH-N) (produced by Fuji Photo Film Co., Ltd.) which had been diluted with water (x4) was poured into a brush type automatic processing machine. Development was occurred at 30° C. After development, the printing plate material was rinsed with water and dried in air to form an image. The resulted image was visually evaluated and image remaining property was determined in accordance with the following valuation basis.

Valuation Basis

∘: formation of sharp image
α: formation of image accompanied with insufficient profiled film remaining property
X no image remaining

(2) Rubbing resistance

Thus formed imaged area was evaluated by using a rubbing tester (RUBBING TESTER manufactured by TAIHEIRIKA). After felt parts for the rubbing tester (produced by TAIHEIRIKA) was set on the rubbing tester and sufficiently wetted with an etching solution (DON-H NS-7 produced by NISSIN Corporation) to contact with the imaged area, the printing plate was rubbed with 2 kg of load at 500 times. Adhesion of the imaged area onto the substrate as well as abrasiveness of the imaged area were visually evaluated. Rubbing resistance was determined in accordance with the following valuation basis.

Valuation Basis

⊚: sharp image remaining with no abrasion
∘: sharp image remaining with slight abrasion
Δ: image remaining with little abrasion
X: image remaining with much abrasion

(3) Ink scumming

A developer (DH-N) (produced by Fuji Photo Film Co., Ltd.) which had been diluted with water (x4) was poured into a brush type automatic processing machine. Printing plate material without laser exposing and drawing was developed at 30° C. The printing plate material was rinsed with water, subjected to squeezing and gumming and dried at 70° C. for 1 minute. Residual gum was removed with running water for 30 seconds, and then the printing plate material was dried at 70° C. for 2 minutes. Newspaper ink was applied thereon by a roller and left for 30 minutes at room temperature. The applied ink was swelled with running water for 20 seconds, and then wiped off with cotton waste (cotton cloth) while water was running. After air drying, ink scumming was visually evaluated. Ink scumming was determined in accordance with the following valuation basis.

Valuation Basis

⊚: No scumming
∘: Remaining slight black stain
Δ: Remaining black stain
X: Blackened

Test Results

TABLE 1

| | Ex. | Ex. | Ex. | Ex. | Ex. | Ex. | Ex. |
|---|---|---|---|---|---|---|---|
| Component | 1 | 2 | 3 | 4 | 5 | 6 | 7 |
| CYCLOMER P (*1) | 60 | 60 | 40 | | 40 | | |
| Acrylic resin I | | | | 60 | | | |
| Acrylic resin II | | | | | 20 | | |
| Acrylic resin III | | | | | | 40 | 40 |
| DPHA (*2) | 140 | 140 | 160 | 140 | 140 | 160 | 160 |
| Near-infrared- | 5 | | | 5 | 5 | 5 | |
| absorbing dye | | | | | | | |
| (*3) | | | | | | | |
| Near-infrared- | | 5 | 5 | | | | 5 |
| absorbing dye | | | | | | | |
| (*4) | | | | | | | |
| Organo borate | 5 | 5 | 5 | 5 | 5 | 5 | 10 |
| (*5) | | | | | | | |
| Triazine (*6) | 5 | 5 | 5 | 5 | 5 | 5 | 5 |
| IRGASTAB UV10 | 0.5 | 0.5 | 0.5 | 0.5 | 0.5 | 0.5 | 0.5 |
| (*7) | | | | | | | |
| Pigment (*8) | 10 | 10 | 10 | 10 | 10 | 10 | 10 |
| Image remaining | ◯ | ◯ | ◯ | ◯ | ◯ | ◯ | ◯ |
| property | | | | | | | |
| immediately after | | | | | | | |
| preparation | | | | | | | |
| Rubbing | ◯ | ◯ | ⊚ | ◯ | ◯ | ◯ | ⊚ |
| resistance | | | | | | | |
| immediately after | | | | | | | |
| preparation | | | | | | | |
| Ink scumming | ⊚ | ⊚ | ⊚ | ⊚ | ⊚ | ⊚ | ⊚ |
| immediately after | | | | | | | |
| preparation | | | | | | | |
| Image remaining | ◯ | ◯ | ◯ | ◯ | ◯ | ◯ | ◯ |
| property | | | | | | | |
| after storage | | | | | | | |
| Rubbing | ◯ | ◯ | ⊚ | ◯ | ◯ | ◯ | ⊚ |
| resistance | | | | | | | |
| after storage | | | | | | | |
| Ink scumming | ⊚ | ⊚ | ⊚ | ⊚ | ⊚ | ⊚ | ⊚ |
| after storage | | | | | | | |

TABLE 2

| | Comp. | Comp. | Comp. | Comp. | Comp. | Comp. | Comp. |
|---|---|---|---|---|---|---|---|
| Component | Ex. 1 | Ex. 2 | Ex. 3 | Ex. 4 | Ex. 5 | Ex. 6 | Ex. 7 |
| CYCLOMER P (*1) | 60 | 60 | 40 | | 40 | | |
| Acrylic resin I | | | | 60 | | | |
| Acrylic resin II | | | | | 20 | | |
| Acrylic resin III | | | | | | 40 | 40 |
| DPHA (*2) | 140 | 140 | 160 | 140 | 140 | 160 | 160 |
| Near-infrared- | 5 | | | 5 | 5 | 5 | |
| absorbing dye | | | | | | | |
| (*3) | | | | | | | |
| Near-infrared- | | 5 | 5 | | | | 5 |
| absorbing dye | | | | | | | |
| (*4) | | | | | | | |
| Organo borate | 5 | 5 | 5 | 5 | 5 | 5 | 10 |
| (*5) | | | | | | | |
| Triazine (*6) | 5 | 5 | 5 | 5 | 5 | 5 | 5 |
| Methoquinone (*9) | 2.5 | 2.5 | 2.5 | 2.5 | 2.5 | 2.5 | 2.5 |
| Pigment (*8) | 10 | 10 | 10 | 10 | 10 | 10 | 10 |
| Image remaining | ◯ | ◯ | ◯ | ◯ | ◯ | ◯ | ◯ |
| property | | | | | | | |
| immediately | | | | | | | |
| after | | | | | | | |
| preparation | | | | | | | |
| Rubbing | ◯ | ◯ | ⊚ | ◯ | ◯ | ◯ | ⊚ |
| resistance | | | | | | | |
| immediately | | | | | | | |
| after | | | | | | | |
| preparation | | | | | | | |
| Ink scumming | ⊚ | ⊚ | ⊚ | ⊚ | ⊚ | ⊚ | ⊚ |
| immediately | | | | | | | |
| after | | | | | | | |
| preparation | | | | | | | |
| Image remaining | ◯ | ◯ | ◯ | ◯ | ◯ | ◯ | ◯ |
| property | | | | | | | |
| after | | | | | | | |
| storage | | | | | | | |
| Rubbing resistance | Δ | Δ | ◯ | Δ | Δ | Δ | ◯ |
| after storage | | | | | | | |
| Ink scumming | Δ | Δ | X | Δ | Δ | X | X |
| after storage | | | | | | | |

(*1) CYCLOMER P is an acrylic copolymer resin having acrylic groups and carboxyl groups as side chain, wherein these acryl groups are introduced by reaction with an alicyclic epoxy group-containing ethylenically unsaturated compound (i.e., 3,4-epoxycyclohexylmethyl acrylate), which is produced and available from DAICEL CHEMICAL INDUSTRIES, LTD.
(*2) dipentaerythritol hexaacrylate
(*3) 1,1,5,5-tetrakis[4-(diethylamino)phenyl]-1,4-pentadien-3-ylium-p-toluenesulfonate (maximum absorption wavelength: 817 nm)
(*4) 2-[2-[2-chloro-3-[(3-ethyl-1,3-dihydro-1,1-dimethyl-2H-benz[e]indol-2-ylidene)ethylidene)-1-cyclohexen-1-yl ]ethenyl]-1,1-dimethyl-3-ethyl-1H-benz[e]indolium tetrafluoroborate (maximum absorption wavelength: 816 nm)
(*5) tetra-n-butyl ammonium triphenyl-n-butylborate
(*6) 2,4,6-tris(trichloromethyl)-S-triazine
(*7) IRGASTAB UV10: bis(1-oxyl-2,2,6,6-tetramethylpiperidin-4-yl)sebacate (manufactured by Ciba)
(*8) phthalocyanine blue (FASTOGEN Blue NK manufactured by DAINIPPON INK AND CHEMICALS INCORPORATED)
(*9) hydroquinone monomethyl ether

It can be seen from Tables 1 and 2 that the photosensitive resin compositions according to the present invention (Examples 1 to 7) have much superior rubbing resistance and no ink scumming to the photosensitive resin composition of Comparative Examples 1 to 7, even immediately after preparation and after 7 days storage under given conditions, and have good stability in a dark.

### Examples 8 to 12 and Comparative Examples 8 to 12

Solution of the photosensitive resin composition (Example 2 or Comparative Example 2) in organic solvent (methoxy propanol, 8%) was applied on an aluminum substrate, which had been hydrophilically treated, by a bar coater, and dried at 80° C. for 5 minutes. The coated amount was ca. 1.5 g/m².

Thereon, one of four formulations A to D described in the following Table 3 (7% aqueous mixed solution) was applied with a bar coater, and dried at 60° C. for 5 minutes to form a protective layer. The coated amount was ca. 1.5 g/m². The prepared printing plate material was left overnight. The photosensitive resin composition was evaluated on image remaining property (with exposure and drawing at 2W, 4W, 6W, 8W or 10W) and rubbing resistance instead of printing durability, with or without exposure under yellow lamp (ca. 250 lux) for 5 hours. Results are shown in Table 4 for each protective layer.

TABLE 3

Formulation

| Solid component | A | B | C | D |
|---|---|---|---|---|
| POVAL 205 (*10) | 90 | — | 90 | — |
| POVAL 505 (*11) | — | 90 | — | 90 |
| PVP/VA W635 (*12) | 10 | 10 | 10 | 10 |
| Surfynol 504 (*13) | 2 | 2 | 2 | 2 |
| C.I. Pigment Blue | 35 | 35 | — | — |
| 15:4 (*14) | | | | |

(*10) partially saponified polyvinyl acetate produced by KURARAY CO., LTD. (saponification value: 88)
(*11) partially sponified polyvinyl acetate produced by KURARAY CO,. LTD. (saponification value: 75)
(*12) vinylpyrrolidone/vinyl acetate copolyer produced by ISP
(*13) acetylene glycol-type surfactant produced by Air Products Japan, Inc.
(*14) pigment dispersion “Himicron K Blue 2453” produced by Mikuni Color Ltd.; solid content: 20.3%; pigment content: 15.6%; average particle size: 103.4 nm; dispersing resin: amine-neutralized copolymer predominantly containing MMA-AA

TABLE 4

| | Example | | | | Comparative Example | | | |
|---|---|---|---|---|---|---|---|---|
| | 8 | 9 | 10 | 11 | 8 | 9 | 10 | 11 |
| photo- | | | | | | | | |
| sensitive | | | | | | | | |
| layer | | | | | | | | |
| protective | Example 2 | | | | Comparative Example 2 | | | |
| layer | A | B | C | D | A | B | C | D |
| Image | good | good | good | good | good | good | good | good |
| remaining | at | at | at | at | at | at | at | at |
| property | 2W | 4W | 2W | 4W | 2W | 4W | 2W | 4W |
| before | | | | | | | | |
| exposure | | | | | | | | |
| Image | good | good | good | good | good | good | —*¹ | —*¹ |
| remaining | at | at | at | at | at | at | | |
| property | 2W | 4W | 2W | 4W | 2W | 4W | | |
| after 5H | | | | | | | | |
| exposure | | | | | | | | |
| Rubbing | ◯ | ◯ | ◯ | ◯ | ◯ | ◯ | ◯ | ◯ |
| resistance | | | | | | | | |
| before | | | | | | | | |
| exposure | | | | | | | | |
| Rubbing | ◯ | ◯ | ◯ | ◯ | ◯ | ◯ | —*² | —*² |
| resistance | | | | | | | | |
| after 5H | | | | | | | | |
| exposure | | | | | | | | |

*¹Photosensitive layer was wholly insolubilized (i.e., cured).
*²Not tested

It can be seen from Table 4 that the composition of Example 2 contains 0.5 parts by weight of the nitroxyl compound (IRGASTAB UV10), and therefore the printing plate material containing the composition have good stability in a bright room with or without addition of a masking dye to the protective layer. On the contrary, it is found that the composition of Comparative Example 2 has poor stability in a bright room (i.e., after 5 hour exposure under yellow lamp), which has the same composition to that of Example 2 with the proviso that the composition of Comparative Example 2 has no nitroxyl compound and the protective layer thereon has no masking dye (see Comparative Examples 10 and 11). In these cases, the photosensitive layers were insolubilized, i.e., cured.

The photosensitive resin composition according to the present invention is useful for a printing plate material which is used as so-called Computer-to-Plate (CTP). The composition can be also applied to various resists such as a negative resist, which is exposed with given light, wherein the exposed area is cured and unexposed area is subjected to alkaline development.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising”, “having”, “including”, and “containing” are to be construed as open-ended terms (i.e., meaning “including, but not limited to,(” unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those skilled in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

The disclosure of Japanese Patent Application No. 2005-267205 filed Sep. 14, 2005 including specification and claims is incorporated herein by reference in its entirety.

What is claimed is:

1. A photosensitive resin composition comprising an ethylenically unsaturated compound, an alkali-soluble resin, a near-infrared-absorbing dye, a halomethyl group-containing compound, a nitroxyl compound and an organo boron anion-containing compound.

2. The photosensitive resin composition according to claim 1, wherein the ethylenically unsaturated compound has 2 to 15 of (meth)acryl groups and molecular weight of 300 to 3,000, and the content of said ethylenically unsaturated compound is 30 to 90 wt %.

3. The photosensitive resin composition according to claim 1, wherein the alkali-soluble resin has acid value of 30 to 150 and weight average molecular weight of 5,000 to 200,000.

4. The photosensitive resin composition according to claim 3, wherein the alkali-soluble resin has no ethylenically unsaturated group.

5. The photosensitive resin composition according to claim 3, wherein the alkali-soluble resin further has an ethylenically unsaturated group as a side chain.

6. The photosensitive resin composition according to claim 5, wherein carboxyl group in the alkali-soluble resin has been reacted with glycidyl(meth)acrylate or an alicyclic epoxy group-containing unsaturated compound to introduce the ethylenically unsaturated group.

7. The photosensitive resin composition according to claim 1, wherein the alkali-soluble resin is an acrylic resin.

8. The photosensitive resin composition according to claim 1, wherein the near-infrared-absorbing dye is a cyanine dye and/or a polymethine dye.

9. The photosensitive resin composition according to claim 8, wherein the near-infrared-absorbing dye has maximum absorption wavelength of 800 to 860 nm.

10. The photosensitive resin composition according to claim 1, wherein the content of the near-infrared-absorbing dye is 0.05 to 20 parts by weight relative to 100 parts by weight of total amount of the ethylenically unsaturated compound and the alkali-soluble resin.

11. The photosensitive resin composition according to claim 1, wherein the content of the halomethyl group-containing compound is 0.1 to 20 parts by weight relative to 100 parts by weight of total amount of the ethylenically unsaturated compound and the alkali-soluble resin.

12. The photosensitive resin composition according to claim 1, wherein the nitroxyl compound is contained in an amount of 0.1 to 1 part by weight relative to 100 parts by weight of total amount of the ethylenically unsaturated compound and the alkali-soluble resin.

13. The photosensitive resin composition according to claim 1, wherein the content of the organo boron anion-containing compound is 0.1 to 20 parts by weight relative to 100 parts by weight of total amount of the ethylenically unsaturated compound and the alkali-soluble resin.

14. The photosensitive resin composition according to claim 1, wherein weight ratio of the near-infrared-absorbing dye, the halomethyl group-containing compound and the organo boron anion-containing compound is 0.1 to 10 (w/w) of said halomethyl group-containing compound/said near-infrared-absorbing dye, and 0.1 to 10 (w/w) of said organo boron anion-containing compound/said near-infrared-absorbing dye.

15. The photosensitive resin composition according to claim 1, which further comprises an organic pigment and/or an organic solvent soluble dye.

16. A printing plate material, which comprises a substrate, a photosensitive layer formed on the substrate, by applying the photosensitive resin composition according to claim 1 on the substrate, and a protective layer without masking dye provided on said photosensitive layer.
